(19) United States
(12) Patent Application Publication
(10) Pub. No.: US 2026/0288222 A1
(43) Pub. Date: Sep. 24, 2026

(54) MEMORY BANDWIDTH REDUCTION FOR POWER SAVINGS

(71) Applicant: Apple Inc., Cupertino, CA (US)

(72) Inventors: Alexander GENDLER, Kiriat Ata (IL); Daniel U. BECKER, San Jose, CA (US); Gregory S. MATHEWS, Saratoga, CA (US)

(21) Appl. No.: 19/084,161

(22) Filed: Mar. 19, 2025

(51) Int. Cl. G06F 1/3225; G06F 13/16

(52) U.S. Cl. CPC G06F 1/3225; G06F 13/1678; G06F 13/1689

(57) ABSTRACT

Memory bandwidth reduction for power savings is disclosed. A memory controller circuit is configured to conduct transactions with a memory circuit. The memory controller circuit includes an external interface circuit configured to receive a plurality of memory transactions, and a bandwidth reduction value. A control circuit of the memory controller circuit is configured to insert, in a particular memory transaction of the plurality of memory transactions having a plurality of slots, a plurality of idle slots using the bandwidth reduction value. A memory interface circuit in the memory controller circuit is configured to send the particular transaction to the memory circuit.

### FIELD

The described embodiments relate generally to computer systems, and more particularly, to memory subsystems.

### BACKGROUND

Memory subsystems typically include a memory controller coupled to at least one memory via a memory bus. Memory transactions conducted between the memory controller and the memory include read transactions and write transactions. These transactions may be conducted in accordance with a clock signal, sometimes known as a data strobe. The frequency of this clock signal may vary with different performance states, which are selected based on a workload demand of the computer system in which the memory subsystem is implemented. The different performance states may also have effects on various other memory subsystem parameters, such as temperature of the various components, memory bandwidth, and power drawn by the memory subsystem.

### BRIEF DESCRIPTION OF THE DRAWINGS

FIG. 1 is a block diagram depicting one embodiment of a memory controller.

FIG. 2 is a drawing illustrating the insertion of idle slots into memory transactions for one embodiment of a memory controller.

FIG. 3 is a block diagram of one embodiment of a system including a memory controller circuit, a memory circuit, and a power management circuit.

FIG. 4 is a flow diagram illustrating one embodiment of a method for operating a memory controller circuit.

FIG. 5 is a block diagram of an embodiment of a device that includes a memory controller circuit in accordance with the disclosure.

FIG. 6 is a block diagram of various embodiments of computer systems that may include a memory controller circuit in accordance with the disclosure.

FIG. 7 illustrates an example of a non-transitory computer-readable storage medium that stores circuit design information.

### DETAILED DESCRIPTION

During operation, a memory controller circuit may conduct numerous memory transactions (both read and write transactions) with a memory circuit. These transactions may drive both power consumption and temperature of the memory circuit. Both power consumption and temperature may have limits, and it is thus desirable to keep the memory circuit within these limits. Overconsumption of power may manifest itself as drawing large amounts of current at a given operating voltage. Exceeding temperature limits (which can be related to overconsumption of power) may occur on a longer timescale.

The present disclosure is directed to a memory controller circuit that may operate to limit power consumption and thermal output of a correspondingly coupled memory circuit through the insertion of idle slots into memory transactions. Memory transactions, both reads and writes, may be conducted in slots, where a slot may represent a write to one memory bank (write slots, for write transactions) or a read from one memory bank (read slots, for read transactions). For an N-bank memory, a memory transaction may include N slots, or a number of slots that is a multiple of N, and may sometimes allow for additional slots due to other timing parameters (e.g., based on bank availability after a previous access). The number of idle slots inserted into a given transaction may be based on a bandwidth reduction value received by the memory controller circuit.

Various embodiments of a system, apparatus, and method for reducing memory bandwidth for power savings (and reducing thermal output) are now discussed in further detail. The disclosure begins with discussion of a memory controller and memory subsystem utilizing bandwidth reduction. A method for operating a memory controller according to the disclosure is then discussed. The disclosure concludes with descriptions of a device, system that may include a memory controller as disclosed herein and computer readable medium that may include design information of the same.

### Memory Controller and Memory Subsystem With Bandwidth Reduction

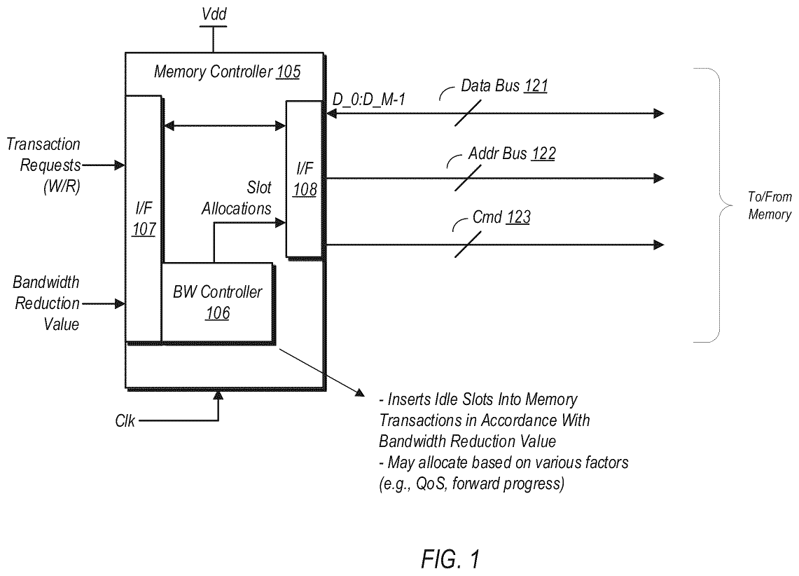

FIG. 1 is a block diagram depicting one embodiment of a memory controller. In the embodiment shown, memory controller 105 is configured for conducting transactions with a memory (not shown here) via data bus 121, address bus 122, and command bus 123. Data bus 121 is a bidirectional bus capable of transferring M bits of data between a memory and memory controller during write transactions and read transactions. Address bus 122 may convey address bits corresponding to a target address for a particular transactions from memory controller 105 to a memory. Command bus 123 may convey commands from memory controller 105, such as read enable commands, write enable commands, and so on. The data, address, and commands may be conveyed through an interface 108 (e.g., such as a physical interface) to the memory. For some implementations, commands and addresses may be conveyed on a unified bus.

A second interface 107 of memory controller 105 is coupled to receive transaction requests and a bandwidth reduction value. The transactions may include both read transactions and write transactions. Write transaction requests are accompanied by data that is to be written to a memory. Transaction requests are additionally accompanied by address bits indicative of an address from which data is to be read or to which data is to be written.

The various transactions carried out by memory controller 105 may be performed in slots. A slot may be the number of memory controller clock cycles it takes to transfer a fixed amount of data (example: 64 bytes) to or from the memory. More generally, a slot is defined herein as a unit of time (a time slot) in which a transaction is conducted with a particular portion of the memory. Write slots are defined herein as slots associated with a write transaction, while read slots are defined as slots associated with a read transaction. For example, for a write transaction, a write slot may be associated with a write of data to a particular bank of memory, with the write transaction comprising a plurality of write slots. Similarly, for a read transaction, particular read slot may be associated with a read of data from a particular bank of memory, with the read transaction comprising a plurality of read slots. An idle slot in a transaction may be a portion of a transaction where data is neither read from nor written to the memory. Idle slots may be inserted into read transactions and write transactions, as is further discussed below. The duration of a single slot may correspond to a current operating frequency of the clock signal (Clk) received by memory controller 105, with higher frequencies corresponding to shorter duration slots (in terms of time). In one embodiment, the duration of a slot may correspond to a period of a single clock cycle, with a 16-slot transaction consuming 16 clock cycles.

A memory to which memory controller 105 is coupled may include a number of different memory banks. The slots of a given transaction correspond to a portion of the transaction focused on one bank. For example, a read transaction with a memory having 16 banks may comprise 16 read slots, with each read slot comprising a read of data from one bank. Similarly, a write transaction with a memory having 16 banks may comprise 16 write slots, with each write slot comprising a write of data to one of the banks. In one embodiment, such transactions may be conducted in a sequence, with each of the banks being accessed. Thus, in the 16-bank examples given above with 16 slots (read or write), each of the banks may be accessed once.

In various embodiments, the number of slots may be greater than the number of banks, e.g., depending on the size of the data to be read or written. For example, a transaction with a memory having 16 banks could have 32 slots, with each bank being read from or written to twice. As discussed above, this may occur in a sequence, such that each bank is written to/read from once for the first 16 slots, and subsequently written to/read from each of the 16 banks for the second 16 slots.

It is further noted that the number of slots in a given transaction may not always correspond to the number of banks or an integer multiple thereof due to certain constraints, such as timing constraints. For example, after accessing a bank, there may be a wait time before that same bank can be accessed again. This may necessitate some idle slots at some clock frequencies, particularly at higher clock frequencies in which all banks may be accessed during a transaction prior to the elapsing of the wait time. However, idle slots may also be inserted into some transactions in accordance with the bandwidth reduction value.

The bandwidth reduction value may be received from an external source, such as a power management circuit. The bandwidth reduction value may indicate to the memory controller an amount that the transaction bandwidth is to be reduced in response to various factors, such as power consumption, temperature, and so on. Since the memory controller may operate at different frequencies of the clock signal, the bandwidth reduction value may be zero at one or more lower frequencies, e.g., when power consumption and temperature of the memory are more likely to be relatively low. At higher clock frequencies, the bandwidth reduction value may be non-zero, and may vary along with system operating conditions. For example, at higher clock frequencies, when memory controller 105 and a memory coupled thereto are consuming more dynamic power, the bandwidth reduction value may be higher than at a lower clock frequency in which the dynamic power consumption is lower. Furthermore, since power consumption may drive thermal output of the memory and memory controller 105, higher bandwidth reduction values may be received by bandwidth controller 106, based on higher temperatures in, e.g., the memory.

In one embodiment, the bandwidth reduction value may be provided as a percentage value. Bandwidth controller 106 in the embodiment shown is a control circuit that may put the bandwidth reduction into effect based on the provided percentage value. This may be carried out by bandwidth controller 106 converting the bandwidth reduction value into idle slots and allocating these idle slots to different transactions. Idle slots may be allocated to read and write transactions, in varying numbers. For example, bandwidth controller may allocate a first number of idle slots to a read transaction and a second number of idle slots to a write transaction occurring subsequent to the read transaction. It is noted that the first and second number of idle slots may differ from one another, and thus bandwidth controller 106 may allocate more idle slots to one of the two transactions.

More generally, bandwidth controller 106, based on the bandwidth reduction value, allocate different numbers of idle slots to different transactions. For example, bandwidth controller 106 may allocate fewer idle slots to certain read transactions to enable the meeting of quality of service (QoS) targets (e.g., for real-time traffic). Idle slots may be allocated among various read and write transactions to also enable the meeting of forward progress targets. Furthermore, bandwidth controller 106 may insert idle slots at the end of a transaction such that various traffic guarantees (including those discussed above) may be met. Where traffic guarantees are not a concern, bandwidth controller 106 may allocate and insert idle slots into a transaction in, e.g., a distributed manner.

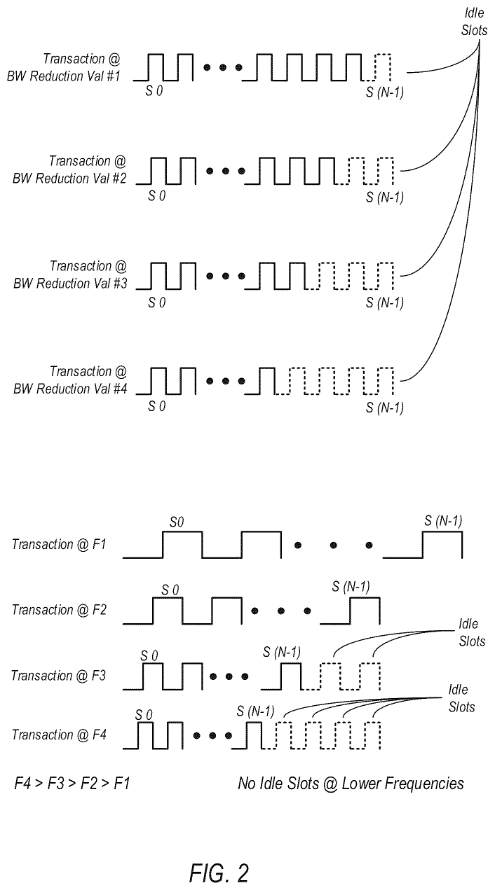

FIG. 2 is a drawing illustrating the insertion of idle slots into memory transactions for one embodiment of a memory controller. More particularly, FIG. 2 illustrates the effect of different bandwidth reduction values and different clock frequencies on the insertion of idle slots.

In the upper portion of FIG. 2, examples of the insertion of idle slots at different bandwidth reduction values is shown. Each of the transactions includes N slots, beginning with slot S0 and concluding with slot S (N−1). The idle slots are indicated by the dashed lines, while the solid line indicates active slots for either a read or a write transaction. As the different bandwidth reduction values increase from Bandwidth Reduction Value #1 to Bandwidth Reduction Value #4, the number of idle slots inserted increases correspondingly. In these examples, the idle slots are inserted at the end of the transactions, although various embodiments of a bandwidth controller 106 may distribute the idle slots in different ways within a given transaction.

In the lower portion of FIG. 2, transactions at different clock frequencies are illustrated, beginning with a low frequency of F1 up to a high frequency of F4. At the two lowest frequencies in this illustration, F1 and F2, no idle slots are inserted. This may correspond to a bandwidth reduction value of zero. A bandwidth reduction value of zero may occur at certain lower clock frequencies when dynamic power consumption is low. Furthermore, since dynamic power consumption may drive temperature changes in the memory, lower values may correspond to lower temperatures.

At the two highest frequencies, F3 and F4, the bandwidth controller 106 may receive a non-zero bandwidth reduction value. At these higher frequencies, dynamic power consumption and temperature may be higher, and thus idle slots may be used to conserve power and keep the memory within specified temperature limits.

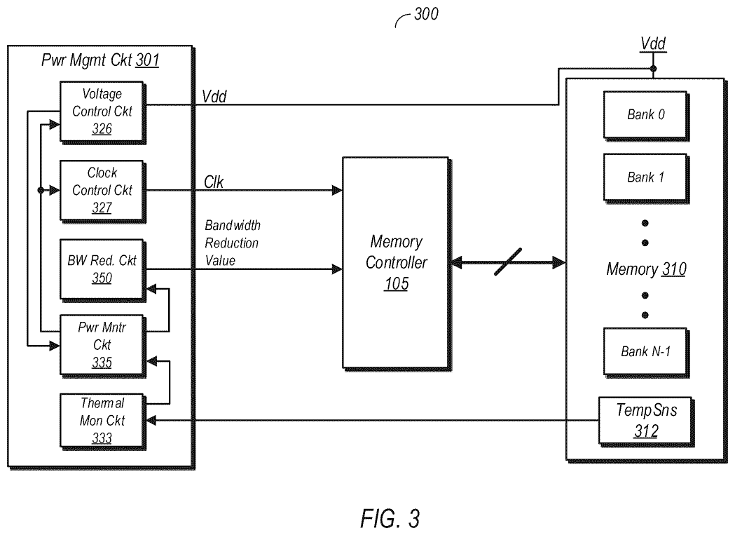

FIG. 3 is a block diagram of one embodiment of a system including a memory controller circuit, a memory circuit, and a power management circuit. System 300 may be part of a larger computer system, system-on-a-chip (SoC) or other arrangement. In the illustrated embodiment, system 300 includes a power management circuit 301, a memory controller 105, and a memory 310. Memory controller 105 as shown here may be configured similarly to that which is shown in FIG. 1, and includes a bandwidth controller 106 (not shown here). Memory 310 in the embodiment shown is a multi-bank memory having N banks (e.g., Bank 0, Bank 1 . . . Bank N−1), and further includes at least one temperature sensor 312 implemented thereon.

Power management circuit 301 may carry out various power management functions, including generation of the bandwidth reduction value that is forwarded to memory controller 105. Power management circuit 301 includes a voltage control circuit 326, a clock control circuit 327, bandwidth reduction circuit 350, power monitoring circuit 335, and thermal monitoring circuit 333.

Voltage control circuit 326 may control the value of the supply voltage Vdd provided to memory controller 105. In some embodiments, voltage control circuit 326 may include one or more power supplies, including that which generates the supply voltage Vdd, which is provided to memory 310 (and may also be provided to memory controller 105). In other embodiments, voltage control circuit 326 may be coupled to power supplies located elsewhere, and may generate control signals to control their operation. The supply voltage Vdd may be generated by, e.g., a multi-phase DC-DC power converter that may add and shed phases in accordance with the load current demand. Voltage control circuit 326 may also generate signals indicative of power consumption by memory controller, e.g., based on the present voltage level of Vdd and the load demand current as measured at the power supply. This value may be provided by voltage control circuit 326 to power monitoring circuit 335.

Clock control circuit 327 may generate the clock signal that is provided to memory controller 105. Since the clock frequency is adjustable, clock control circuit 327 may include one or more circuits (e.g., clock dividers or clock multipliers) to change the frequency.

Thermal monitoring circuit 333 is configured to receive temperature readings from one or more temperature sensors, including temperature sensor 312 of memory 310. Thermal monitoring circuit 333 may also include one or more comparison circuits to compare received temperature readings to one or more temperature thresholds. Results of these comparisons are forwarded to power monitoring circuit 335.

Using the received power consumption values received from voltage control circuit 326 and the temperature comparison results received from thermal monitoring circuit 333, power monitoring circuit 335 may perform various actions. These action may include selecting a performance state for memory controller 105, and thus the memory subsystem as a whole (which also includes memory 310). A performance state as defined herein includes a unique combination of a clock frequency and supply voltage.

Power monitoring circuit 335 may also provide an indication of the selected performance state to bandwidth reduction circuit 350, and may additionally provide information regarding the power consumption and the temperature comparison results used as a basis for selecting the performance state. Using this information, bandwidth reduction circuit 350 may generate a bandwidth reduction value that is then forwarded to a bandwidth controller of memory controller 105. The bandwidth reduction value may change during operation in accordance with other changes carried out by power monitoring circuit 335.

### Method of Operation

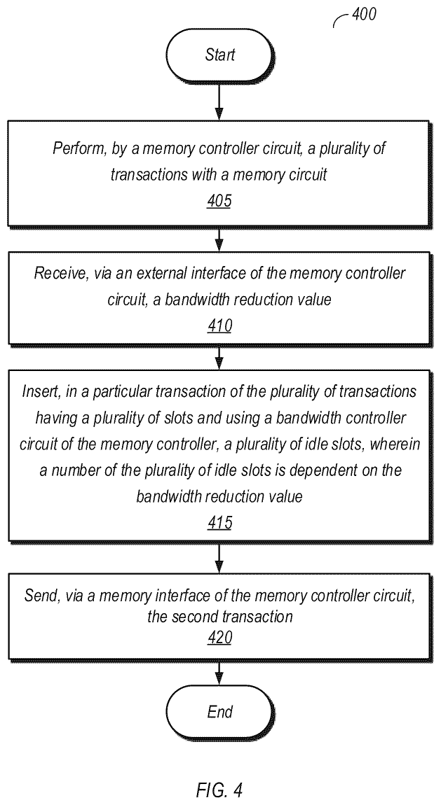

FIG. 4 is a flow diagram illustrating the operation of one embodiment of a memory controller circuit in accordance with the disclosure. Method 400 may be carried out by various embodiments of a memory controller circuit as discussed above. Embodiments of a memory controller circuit capable of carrying out Method 400, but not explicitly discussed herein, are nevertheless considered to fall within the scope of this disclosure.

Method 400 includes performing, by a memory controller circuit, a plurality of transactions with a memory circuit (block 405). The method further includes receiving, via an external interface of the memory controller circuit, a bandwidth reduction value (block 410). The method also includes inserting, in a particular transaction of the plurality of transactions having a plurality of slots and using a bandwidth controller circuit of the memory controller, a plurality of idle slots, wherein a number of the plurality of idle slots is dependent on the bandwidth reduction value (block 415) and sending, via a memory interface of the memory controller circuit, the particular transaction (block 420).

In various embodiments, the plurality of transactions includes a plurality of read transactions and a plurality of write transactions. In such embodiments, the method may further include inserting, in a plurality of read slots of a particular one of the plurality of read transactions, a first number of idle slots of the plurality of idle slots and inserting, in a plurality of write slots of a particular one of the plurality of write transactions, a second number of idle slots of the plurality of idle slots. Such embodiments may also include allocating, using the bandwidth controller circuit, ones of the plurality of read slots, including the first number of idle slots based on quality of service (QoS) targets.

Embodiments of Method 400 may further include allocating ones of the plurality of idle slots, using the bandwidth controller circuit, based on forward progress targets.

The memory controller circuit may be coupled to a power management circuit. Accordingly, some embodiments of the method include generating and forwarding to the memory controller circuit, using the power management circuit, the bandwidth reduction value. In such embodiments, generating the bandwidth reduction value comprises one or more of the following: generating the bandwidth reduction value based on temperature readings received from one or more temperature sensors associated with the memory and generating the bandwidth reduction value based on power consumption by the memory circuit and one or more power consumption limits.

Various embodiments of a memory controller circuit in accordance with the disclosure may be capable of operation at different clock frequencies. Accordingly, the method may include operating the memory controller at a first clock frequency and operating the memory controller at a second clock frequency, wherein the second clock frequency is less than the first clock frequency. The bandwidth reduction value at the second clock frequency is zero, wherein the bandwidth reduction value at the first clock frequency is a non-zero value.

Some embodiments of the method may also include the bandwidth controller circuit inserting ones of plurality of idle slots in a given one of the plurality of transactions subsequent to meeting traffic guarantees.

### Device, System, and Computer Readable Medium

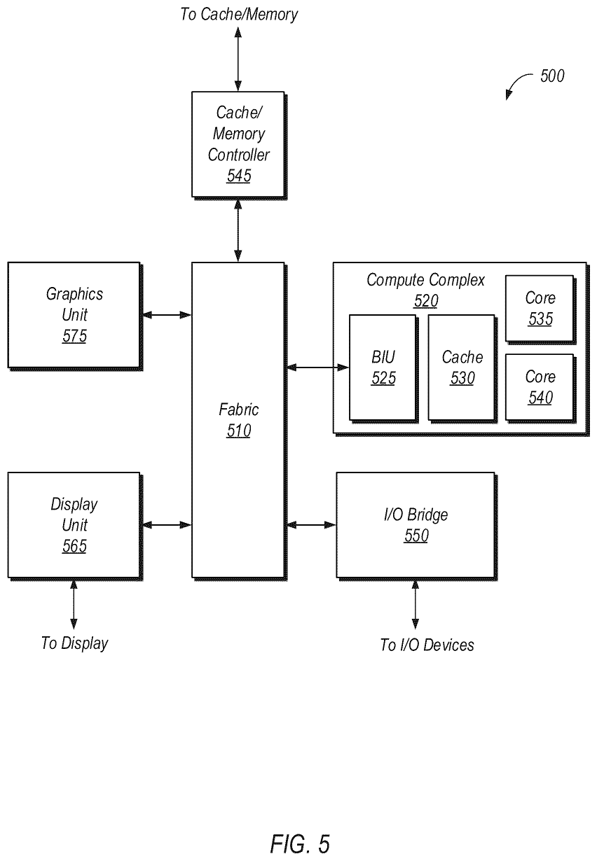

Referring now to FIG. 5, a block diagram illustrating an example embodiment of a device that may include a memory controller in accordance with the disclosure. In some embodiments, elements of device 500 may be included within a system on a chip. In some embodiments, device 500 may be included in a mobile device, which may be battery-powered. Therefore, power consumption by device 500 may be an important design consideration. In the illustrated embodiment, device 500 includes fabric 510, compute complex 520, input/output (I/O) bridge 550, cache/memory controller 545, graphics unit 575, and display unit 565. In some embodiments, device 500 may include other components (not shown) in addition to, or in place of, the illustrated components, such as video processor encoders and decoders, image processing or recognition elements, computer vision elements, etc.

Fabric 510 may include various interconnects, buses, MUX's, controllers, etc., and may be configured to facilitate communication between various elements of device 500. In some embodiments, portions of fabric 510 may be configured to implement various different communication protocols. In other embodiments, fabric 510 may implement a single communication protocol, and elements coupled to fabric 510 may convert from the single communication protocol to other communication protocols internally.

In the illustrated embodiment, compute complex 520 includes bus interface unit (BIU) 525, cache 530, and cores 535 and 540. In various embodiments, compute complex 520 may include various numbers of processors, processor cores, and caches. For example, compute complex 520 may include 1, 2, or 4 processor cores, or any other suitable number. In one embodiment, cache 530 is a set associative L2 cache. In some embodiments, cores 535 and 540 may include internal instruction and data caches. In some embodiments, a coherency unit (not shown) in fabric 510, cache 530, or elsewhere in device 500, may be configured to maintain coherency between various caches of device 500. BIU 525 may be configured to manage communication between compute complex 520 and other elements of device 500. Processor cores, such as cores 535 and 540, may be configured to execute instructions of a particular instruction set architecture (ISA) which may include operating system instructions and user application instructions. These instructions may be stored in a computer readable medium such as a memory coupled to cache memory controller 545 as discussed below.

As used herein, the term “coupled to” may indicate one or more connections between elements, and a coupling may include intervening elements. For example, in FIG. 5, graphics unit 575 may be described as “coupled to” a memory through fabric 510 and cache/memory controller 545. In contrast, in the illustrated embodiment of FIG. 5, graphics unit 575 is “directly coupled” to fabric 510 because there are no intervening elements.

Cache/memory controller 545 may be configured to manage transfer of data between fabric 510 and one or more caches and memories. For example, cache/memory controller 545 may be coupled to an L3 cache, which may, in turn, be coupled to a system memory. In other embodiments, cache/memory controller 545 may be directly coupled to a memory. In some embodiments, cache/memory controller 545 may include one or more internal caches. Memory coupled to cache/memory controller 545 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 545 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 520 to cause the computing device to perform functionality described herein.

Graphics unit 575 may include one or more processors, e.g., one or more graphics processing units (GPUs). Graphics unit 575 may receive graphics-oriented instructions, such as OPENGL®, Metal®, or DIRECT3D® instructions, for example. Graphics unit 575 may execute specialized GPU instructions or perform other operations based on the received graphics-oriented instructions. Graphics unit 575 may generally be configured to process large blocks of data in parallel, and may build images in a frame buffer for output to a display, which may be included in the device or may be a separate device. Graphics unit 575 may include transform, lighting, triangle, and rendering engines in one or more graphics processing pipelines. Graphics unit 575 may output pixel information for display images. Graphics unit 575, in various embodiments, may include programmable shader circuitry which may include highly parallel execution cores configured to execute graphics programs, which may include pixel tasks, vertex tasks, and compute tasks (which may or may not be graphics-related).

Display unit 565 may be configured to read data from a frame buffer and provide a stream of pixel values for display. Display unit 565 may be configured as a display pipeline in some embodiments. Additionally, display unit 565 may be configured to blend multiple frames to produce an output frame. Further, display unit 565 may include one or more interfaces (e.g., MIPI® or embedded display port (eDP)) for coupling to a user display (e.g., a touchscreen or an external display).

I/O bridge 550 may include various elements configured to implement universal serial bus (USB) communications, security, audio, and low-power always-on functionality, for example. I/O bridge 550 may also include interfaces such as pulse-width modulation (PWM), general-purpose input/output (GPIO), serial peripheral interface (SPI), and inter-integrated circuit (I2C), for example. Various types of peripherals and devices may be coupled to device 500 via I/O bridge 550.

In some embodiments, device 500 includes network interface circuitry (not explicitly shown), which may be connected to fabric 510 or I/O bridge 550. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 500 with connectivity to various types of other devices and networks.

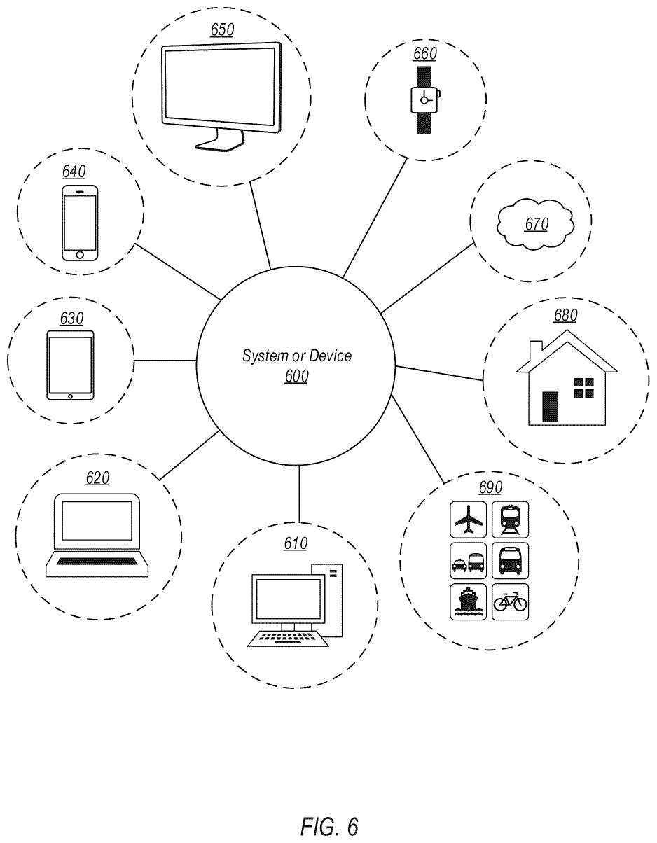

Turning now to FIG. 6, various types of systems that may include any of the circuits, devices, or systems discussed above are illustrated. System or device 600, which may incorporate or otherwise utilize one or more of the techniques described herein, may be utilized in a wide range of areas. For example, system or device 600 may be utilized as part of the hardware of systems such as a desktop computer 610, laptop computer 620, tablet computer 630, cellular or mobile phone 640, or television 650 (or set-top box coupled to a television).

Similarly, disclosed elements may be utilized in a wearable device 660, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 600 may also be used in various other contexts. For example, system or device 600 may be utilized in the context of a server computer system, such as a dedicated server or on shared hardware that implements a cloud-based service 670. Still further, system or device 600 may be implemented in a wide range of specialized everyday devices, including devices 680 commonly found in the home such as refrigerators, thermostats, security cameras, etc. The interconnection of such devices is often referred to as the “Internet of Things” (IoT). Elements may also be implemented in various modes of transportation. For example, system or device 600 could be employed in the control systems, guidance systems, entertainment systems, etc. of various types of vehicles 690.

The applications illustrated in FIG. 6 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

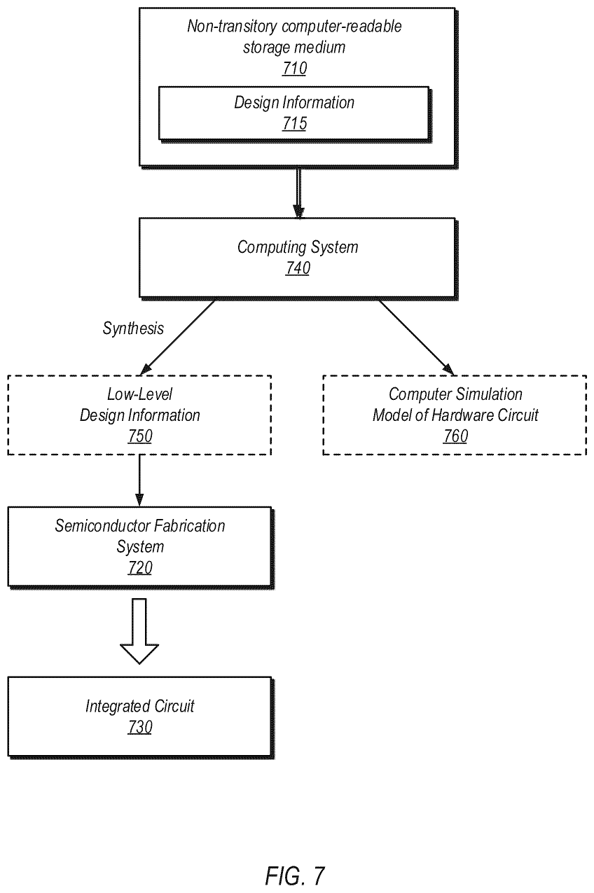

FIG. 7 is a block diagram illustrating an example of a non-transitory computer-readable storage medium that stores design information 715, according to some embodiments. In the illustrated embodiment, computing system 740 is configured to process design information 715. This may include executing instructions included in design information 715, interpreting instructions included in design information 715, compiling, transforming, or otherwise updating design information 715, etc. Therefore, design information 715 controls computing system 740 (e.g., by programming computing system 740) to perform various operations discussed below, in some embodiments.

In the illustrated example, computing system 740 processes design information 715 to generate both computer simulation model of hardware circuit 760 and low-level design information 750. In other embodiments, computing system 740 may generate only one of these outputs, may generate other outputs based on design information 715, or both. Regarding computer simulation model of hardware circuit 760, computing system 740 may execute instructions of a hardware description language that includes register transfer level (RTL) code, behavioral code, structural code, or some combination thereof. The simulation model may perform the functionality specified by design information 715, facilitate verification of the functional correctness of the hardware design, generate power consumption estimates, generate timing estimates, etc.

In the illustrated example, computing system 740 also processes design information 715 to generate low-level design information 750 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 750 (potentially among other inputs), semiconductor fabrication system 720 is configured to fabricate integrated circuit 730 (which may correspond to functionality of the computer simulation model of hardware circuit 760). Note that computing system 740 may generate different simulation models based on design information at various levels of description, including low-level design information 750, design information 715, and so on. The data representing low-level design information 750 and computer simulation model of hardware circuit 760 may be stored on non-transitory computer-readable storage medium 710, or on one or more other media.

In some embodiments, low-level design information 750 controls (e.g., programs) semiconductor fabrication system 720 to fabricate integrated circuit 730. Thus, when processed by the fabrication system, the design information may program the fabrication system to fabricate a circuit that includes various circuitry disclosed herein.

Non-transitory computer-readable storage medium 710 may comprise any of various appropriate types of memory devices or storage devices. Non-transitory computer-readable storage medium 710 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 710 may include other types of non-transitory memory as well, or combinations thereof. Accordingly, non-transitory computer-readable storage medium 710 may include two or more memory media, which may reside in different locations for example, in different computer systems that are connected over a network.

Design information 715 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 740, semiconductor fabrication system 720, or both. In some embodiments, design information 715 may also include one or more cell libraries that specify the synthesis, layout, or both of integrated circuit 730. In some embodiments, design information 715 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 730 may, in various embodiments, include one or more custom macrocells, such as memories, analog or mixed-signal circuits, and the like. In such cases, design information 715 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 720 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 720 may also be configured to perform various testing of fabricated circuits for correct operation.

In various embodiments, integrated circuit 730 and computer simulation model of hardware circuit 760 are configured to operate according to a circuit design specified by design information 715, which may include performing any of the functionality described herein. For example, integrated circuit 730 may include any of various elements shown in FIGS. 1-7. Further, integrated circuit 730 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 715. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 715 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 750. Low-level design information 750 may program semiconductor fabrication system 720 to fabricate integrated circuit 730.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A system comprising:
a memory circuit; and
a memory controller circuit configured to conduct transactions with the memory circuit, wherein the memory controller circuit includes a bandwidth controller circuit configured to:
perform a plurality of transactions with the memory circuit;
receive, via an interface of the memory controller, a bandwidth reduction value; and
insert, in a particular transaction of the plurality of transactions having a plurality of slots, one or more idle slots, wherein the number of the one or more idle slots is dependent on the bandwidth reduction value.

2. The system of claim 1, wherein the plurality of transactions includes:
a plurality of read transactions, wherein a given one of the plurality of read transactions comprises a plurality of read slots; and
a plurality of write transactions, wherein a given one of the plurality of write transactions comprises a plurality of write slots;
wherein the one or more idle slots includes a first number of idle slots inserted into the given one of the plurality of read transactions and a second number of idle slots inserted into the given one of the plurality of write transactions.

3. The system of claim 2, wherein the bandwidth controller circuit is configured to allocate ones of the plurality of read slots and ones of the first number of idle slots based on quality of service (QoS) targets.

4. The system of claim 1, wherein the bandwidth controller circuit is configured to allocate ones of the one or more idle slots based on forward progress targets.

5. The system of claim 1, further comprising a power management circuit configured to generate and forward the bandwidth reduction value to the memory controller circuit.

6. The system of claim 5, wherein the power management circuit is configured to receive temperature readings from at least one temperature sensor associated with the memory, circuit, and further configured to generate the bandwidth reduction value based on the temperature readings.

7. The system of claim 5, wherein the power management circuit is configured to monitor power consumption by the memory circuit, and further configured to generate the bandwidth reduction value based on the power consumption by the memory circuit and one or more power consumption limits.

8. The system of claim 1, wherein the memory controller circuit is configured to operate at ones of a plurality of different clock frequencies including a first subset of clock frequencies and a second subset of clock frequencies, wherein ones of the second subset of clock frequencies are greater than ones of the first subset of clock frequencies, and wherein, for the first subset of clock frequencies, the bandwidth reduction value is zero.

9. The system of claim 1, wherein the bandwidth controller circuit is configured to insert, in a given one of the plurality of transactions and subsequent to meeting traffic guarantees, ones of the one or more idle slots.

10. A method comprising:
performing, by a memory controller circuit, a plurality of transactions with a memory circuit;
receiving, via an external interface of the memory controller circuit, a bandwidth reduction value;
inserting, in a particular transaction of the plurality of transactions having a plurality of slots and using a bandwidth controller circuit of the memory controller, one or more idle slots, wherein a number of the one or more idle slots is dependent on the bandwidth reduction value; and
sending, via a memory interface of the memory controller circuit, the particular transaction.

11. The method of claim 10, wherein the plurality of transactions includes a plurality of read transactions and a plurality of write transactions, and wherein the method further comprises:
inserting, in a plurality of read slots of a particular one of the plurality of read transactions, a first number of idle slots of the one or more idle slots; and
inserting, in a plurality of write slots of a particular one of the plurality of write transactions, a second number of idle slots of the one or more idle slots.

12. The method of claim 11 further comprising allocating, using the bandwidth controller circuit, ones of the plurality of read slots, including the first number of idle slots based on quality of service (QoS) targets.

13. The method of claim 10, further comprising allocating ones of the one or more idle slots, using the bandwidth controller circuit, based on forward progress targets.

14. The method of claim 10, further comprising generating and forwarding to the memory controller circuit, using a power management circuit, the bandwidth reduction value, wherein generating the bandwidth reduction value comprises one or more of the following:
generating the bandwidth reduction value based on temperature readings received from one or more temperature sensors associated with the memory; and
generating the bandwidth reduction value based on power consumption by the memory circuit and one or more power consumption limits.

15. The method of claim 10, further comprising:
operating the memory controller at a first clock frequency; and
operating the memory controller at a second clock frequency, wherein the second clock frequency is less than the first clock frequency;
wherein the bandwidth reduction value at the second clock frequency is zero, and wherein the bandwidth reduction value at the first clock frequency is a non-zero value.

16. The method of claim 10, further comprising the bandwidth controller circuit inserting, in a given one of the plurality of transactions and subsequent to meeting traffic guarantees, ones of one or more idle slots.

17. An apparatus, comprising:
a memory controller circuit configured to conduct transactions with a memory circuit, the memory controller circuit comprising:
an external interface circuit configured to receive a plurality of memory transactions, and a bandwidth reduction value;
a control circuit configured to insert, in a particular memory transaction of the plurality of memory transactions having a plurality of slots, one or more idle slots using the bandwidth reduction value; and
a memory interface circuit configured to send the particular memory transaction to the memory circuit.

18. The apparatus of claim 17, further comprising a power management circuit coupled to the memory controller circuit, wherein the power management circuit is configured to generate the bandwidth reduction value based on one or more of the following:
a temperature of the memory circuit; and
power consumption by the memory circuit.

19. The apparatus of claim 17, wherein the memory controller circuit is configured to operate at ones of a plurality of different clock frequencies including a first subset of clock frequencies and a second subset of clock frequencies, wherein ones of the second subset of clock frequencies are greater than ones of the first subset of clock frequencies, and wherein, for the first subset of clock frequencies, the bandwidth reduction value is zero.

20. The apparatus of claim 17, wherein the plurality of memory transactions includes:
a plurality of read transactions, wherein a given one of the plurality of read transactions comprises a plurality of read slots; and
a plurality of write transactions, wherein a given one of the plurality of write transactions comprises a plurality of write slots;
wherein the one or more idle slots includes a first number of idle slots inserted into the given one of the plurality of read transactions and a second number of idle slots inserted into the given one of the plurality of write transactions.
